(19) United States
(12) Patent Application Publication
(10) Pub. No.: US 2011/0219633 A1
(43) Pub. Date: Sep. 15, 2011

(54) Apparatus and methods for determining angular offset between objects

(76) Inventor: Anthony Hanna, Tyler, TX (US)

(21) Appl. No.: 12/661,169

(22) Filed: Mar. 12, 2010

(51) Int. Cl. G01B 1/00; G01C 9/00

(52) U.S. Cl. 33/286; 33/529; 33/365

(57) ABSTRACT

Apparatuses and methods for determining angular offset and facilitating engagement between conduits, vessels, and/or other objects are disclosed. A plurality of members are provided, each member being pivotally connected to at least one adjacent member. One or more measurement devices are provided in association with adjacent members, such that the angular relationship between adjacent members can be measured. In use, the apparatus is secured to a first object, while a laser or other visual indication device is used to produce a visible indication. The members are moved relative to one another to position the visible indication on a second object. The measurement devices can then be used to determine the angular relationship between the members, thereby enabling the angular offset between the first and second objects to be determined. Using this information, the optimal route, number, and/or angles for a conduit string engaging the two objects can be calculated.

### FIELD

The present disclosure relates, generally, to apparatuses and methods usable to determine angular offset between objects, such as the angular offset between tanks or other vessels, and pipes or other conduits, to facilitate engagement between the conduits and vessels.

### BACKGROUND

Engagement of a pipeline or similar conduit with a tank or other vessel, such as those used to contain hydrocarbons or other liquids, is a precise operation that must be performed in accordance with numerous codes, regulations, and/or industry standards. Similarly, engagement between two segments of conduit must also be performed in accordance with such requirements. For example, before cutting an orifice in the exterior of a tank to accommodate engagement with a pipe, it must be ensured that this orifice does not interfere with the horizontal or vertical weld pattern of the tank, or any preexisting manholes, orifices, or other features. Formation of an orifice that interferes with such features can cause a system of conduits and/or tanks to fail to comply with required codes, regulations, or standards, and can create a hazardous situation. Additionally, under many circumstances, features of a tank can cause formation of an orifice in certain locations to be impossible.

Conventional processes for engaging a length of conduit with a remote vessel or a second length of conduit require sequential segments of conduit to be cut and welded together, each successive segment approximating the angle necessary to engage the first conduit with the target vessel or conduit. Each cut and subsequent weld requires time, labor, materials, and precise measurements, thereby increasing the cost of the overall operation. Additionally, every cut and weld required carries an inherent potential for human error, which can result in leaks, improper alignment between components, or other sources of damage. Furthermore, each weld and angular bend within a conduit string creates a point that is exposed to wear caused by fluid flow, which can result in eventual failure, and can require costly and time consuming remedial operations. These difficulties can be exacerbated when a conduit must be extended through a lengthy or convoluted route to engage a portion of a vessel or second conduit that is angularly offset from the first, or when extending a conduit string through a region where it may cross or otherwise interfere with existing conduits. It is therefore desirable to determine the most direct and optimal route between two objects to be engaged that will require a minimum number of conduit segments, welds, and angular bends.

A need exists for apparatuses and methods useable to efficiently and accurately determine the angular offset between a first object and a second object to which the first is to be engaged, and/or between the first object and a location through which it is desired to extend a conduit from the first object, thereby enabling an optimal system of engagement to be formed therebetween.

Embodiments of the present invention meet these needs.

### BRIEF DESCRIPTION OF THE DRAWINGS

In the detailed description of various embodiments of the present invention presented below, reference is made to the accompanying drawings, in which:

FIG. 1A depicts a top view of an embodiment of an apparatus useable within the scope of the present disclosure.

FIG. 1B depicts a side view of the apparatus of FIG. 1A.

FIG. 2A depicts an embodiment of an apparatus useable within the scope of the present disclosure engaged with a first object.

FIG. 2B depicts the apparatus of FIG. 2A after movement of one or more parts thereof.

Embodiments of the present invention are described below with reference to the listed Figures.

### DETAILED DESCRIPTION OF THE EMBODIMENTS

Before explaining selected embodiments of the present invention in detail, it is to be understood that the present invention is not limited to the particular embodiments described herein and that the present invention can be practiced or carried out in various ways.

Embodiments of the present invention relate to apparatuses and methods usable to determine angular offset between conduits and vessels, or other objects, for facilitating engagement therebetween. An embodiment of the apparatus can include a first member pivotally engaged with a second member, such that the second member is movable relative to the first along a first axis, and a third member pivotally engaged with the second member, such that the third member is pivotally moveable relative to the second along a second axis. A measurement device, such as a protractor, a clinometer, a goniometer, an angular sensor, or other similar devices usable to determine the angular relationship between members, can be disposed in operative association with the first and second members. A similar measurement device can be disposed in operative association with the second and third members. Each measurement device is thereby usable to measure the angular relationship between the members with which it is operatively associated.

The first member can also include a bubble level, water level, spirit level, laser line level, inclinometer, plumb, or similar measurement device disposed in operative association therewith, such that the first member can be placed generally parallel or at a known angle relative to the Earth's surface, or another reference surface. Additionally, the first member can include one or more fasteners, a mounting bracket, one or more adhesives, or a similar component to enable attachment of the apparatus to one of the two objects to be engaged. For example, the first member can have a mounting bracket secured to an end, the mounting bracket including one or more bolts, pins, screws, or similar protruding members usable to engage orifices within a flange of a pipe or similar tubular member. In an embodiment of the invention, the mounting bracket can include one or more adjustable members for accommodating objects of varying diameter. Alternatively or additionally, the first member can include one or more ferromagnetic members usable to engage an at least partially ferrous surface of the object. In a further embodiment of the invention, the apparatus could be adapted for secure engagement to the exterior of a segment of pipe or a tank.

The third member can include a location indication device, which can include as a laser device or other light-emitting device, engaged therewith and usable to provide an indication to the target object, thereby facilitating positioning of the second and third members to determine the angular offset of the second object relative to the first object.

In operation, the first member can be secured to a pipe, tank, or other object, such as through use of a mounting bracket or similar securing device, as described previously. The first member can then be aligned or placed at a known angle relative to the Earth's surface, or another desired surface, such as through adjustment of the mounting bracket or other securing device, used in conjunction with a level or another type of angular measurement device.

The laser device or other type of indication device disposed on the third member can then be actuated to produce an indication, and the second member can be pivoted relative to the first member along the horizontal axis, or another selected axis, until the indication is aligned with the selected object to which the first object is to be engaged, with respect to the first axis. Similarly, the third member can be pivoted relative to the second member along the vertical axis, or other selected axis, until the indication is aligned with the selected object with respect to the second axis. The angular offset of the second object relative to the first object along the two axes can then be determined through use of the protractors, or other angular measurement devices, which measure the angles between adjacent arms of the apparatus.

It should be understood that embodiments of the present invention are also usable to provide and indication at a known and/or selected angular relationship relative to a first object. For example, if the angular offset between a conduit and a portion of the tank suitable for engagement with the conduit is known, the moveable members of the apparatus can be positioned relative to one another in a manner which corresponds to the angular offset between the conduit and the tank, using the protractors or other angular measurement devices to determine the correct position for each member. The laser device or other location indication device can then be actuated to provide an indication to the desired portion of the tank, which can be used to facilitate cutting or otherwise preparing the tank for engagement with the conduit. For example, if it is desired to engage the tank with a segment of pipe having a diameter of 36 inches, use of a laser or similar device to provide a visible indication at the precise center of the desired portion of the tank can enable an operator to efficiently and accurately form an orifice with a corresponding diameter at the proper location.

In an embodiment of the invention, a level or similar measurement device can be provided in operative association with the location indication device to ensure that the indication is produced generally parallel, or at a known angle relative to the Earth's surface, or relative to another reference surface. Use of such a feature can prevent any inaccuracy or uncertainty that could be created through an unknown angular relationship between the location indication device and one or more other portions of the apparatus.

In a further embodiment of the invention, the apparatus can include a distance measurement device, which can be integral with the location indication device, or separate therefrom. For example, the location indication device can include a laser distance sensor, usable to both provide a visual indication to an object while simultaneously determining the distance between the sensor and the object. Once the angular offset, and optionally the distance, between two objects is known, an engineer or other operator can efficiently and accurately determine the optimal route and number of conduits and/or angles for engagement between the objects. By example, when engaging a pipeline with a tank, it is common to utilize the equation: d=a*0.4142, where d represents the distance from the centerline of the tank to the starting point of the offset, a represents the distance from the center of the tank to the center of the pipe, and 0.4142 is a known constant. When the distance from the center of the tank to the center of the pipe is not known, it can be determined by adding the distance from the side of the tank to the center of the pipe to one-half the width or diameter of the tank.

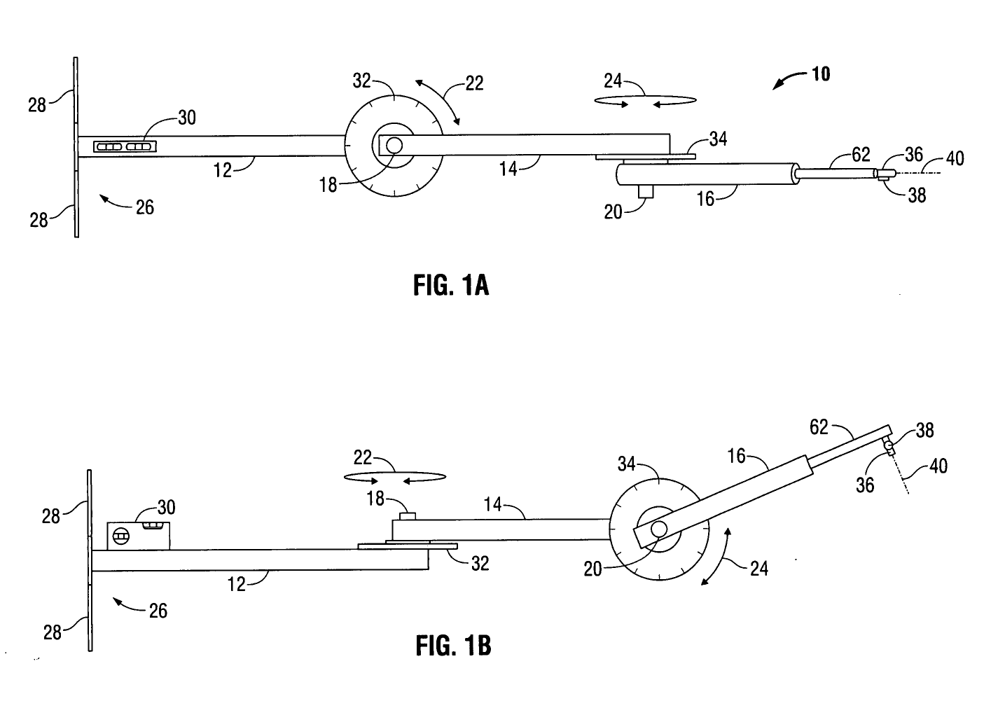

Referring now to FIGS. 1A and 1B, a side view and a top view, respectively, of an embodiment of an apparatus (10) usable within the scope of the present disclosure is shown. The body of the apparatus (10) is shown having a first member (12) pivotally engaged with a second member (14), which is in turn pivotally engaged with a third member (16). While FIGS. 1A and 1B depict each member (12, 14, 16) as a generally tubular component, it should be understood any or all of the members (12, 14, 16) can be provided with any desired shape or dimensions, including without limitation generally cylindrical, rectangular, triangular, or flat shapes. Each member (12, 14, 16) can be formed from any generally rigid material, such as metal, plastic, rubber, wood, one or more polymers, one or more composites, or combinations thereof. In an embodiment of the invention, the members (12, 14, 16) can be formed from generally lightweight, waterproof, rust and/or shock resistant materials, such as aluminum. Alternatively or additionally, the members (12, 14, 16) can be coated or otherwise treated to resist moisture, extreme temperatures, exposure to hydrocarbons or other liquids or gasses transported within conduits, and other ambient conditions.

The engagements (18, 20) between each adjacent member can include any manner of pin, hinge, bolt, or other fastener, or any other engagement that enables pivotal movement between adjacent members. To facilitate fixedly positioning each member (12, 14, 16) in a selected orientation relative to adjacent members, the engagements (18, 20) can include any manner of geared or ratcheting engagement, one or more clamps or other fasteners, one or more biasing members, one or more tightenable bolts, nuts, and/or thumb screws, or any other locking or securing mechanism usable to selectively affix the position of one of the members (12, 14, 16) relative to another of the members. FIGS. 1A and 1B depict the second member (14) pivotable relative to the first member (12) along a first, generally horizontal axis (22), while the third member (16) is shown being pivotable relative to the second member (14) along a second, generally vertical axis (24). It should be understood that while the first axis (22) is shown generally parallel to the Earth's surface and generally perpendicular to the second axis (24), embodiments of the depicted apparatus (10) can be configured such that the members (12, 14, 16) are pivotable relative to one another along any axes. Further, the axes can have any angular relationship therebetween, including, without limitation, a perpendicular relationship. Additionally, while the depicted apparatus (10) is shown having three members (12, 14, 16) moveable in a manner that facilitates determination of angular offset along two differing axes, when it is desirable to determine the angular offset of a second object relative to a first object along only a single axis, embodiments of the present invention can include an apparatus having only two pivotally connected members, movable relative to one another along the single axis.

The first member (12) is shown having a mounting bracket (26) secured to an end opposite the engagement (18) between the first member (12) and the second member (14). The mounting bracket (26) is depicted having protruding members (28) useable to accommodate bolts or other fasteners, extending therefrom for engagement with orifices within the flange of a pipe, or with complementary orifices within any object intended to be engaged with another object. In an embodiment of the invention, the mounting bracket (26) can include one or more adjustable, expandable, and/or moveable portions usable such that the depicted apparatus (10) can accommodate tubular members or other objects having a range of diameters, shapes, and/or dimensions. In a further embodiment of the invention, the mounting bracket (26) can include one or more ferromagnetic members in place of, or in addition to, the bolts or other fasteners, for securing the apparatus (10) to a ferrous surface of an object. It should be understood that while FIGS. 1A and 1B depict a mounting bracket (26) adapted for engagement with a pipe flange, other devices usable to attach the first member (12) or any other portion of the depicted apparatus (10) to an object are usable. For example, the apparatus (10) could be magnetically or physically secured to or around the exterior of a pipe or tank using any manner of magnets, straps, bands, frames, or similar elements.

A level (30) is also shown disposed on the first member (12), which is usable to determine the angle of the first member (12) relative to the Earth's surface, such that the mounting bracket (26) or other securing member can be adjusted to align the first member (12) with the Earth's surface. It should be understood that while FIGS. 1A and 1B depict a bubble level (30), any type of angular measurement device is usable to determine the relationship between the first member (12) and the Earth's surface, or any desired reference surface.

A first protractor (32) is shown operatively secured proximate to the engagement (18) between the first member (12) and the second member (14), while a second protractor (34) is shown operatively secured proximate to the engagement (20) between the second member (14) and the third member (16). Each protractor (32, 34) is thereby usable to determine the angular relationship between the two members with which it is operatively associated. It should be understood that while FIGS. 1A and 1B depict protractors (32, 34) operatively engaged with the members (12, 14, 16), any type of manual or automatic angular sensor or other angular measuring device can be used to determine the angular relationship between adjacent members.

A laser device (36) is shown secured to the third member (16) via an adjustable arm (62), for producing a laser beam (40) usable to provide a visible indication to a remote object. Generally, laser devices and other location indication devices that provide a focused beam of light are able to provide a visible indication to an object up to one mile away, or farther; however, other types of devices usable to provide an indication to a remote object are also usable. A level (38) or similar angular measurement device can be used to ensure alignment of the laser device (36) with the Earth's surface, or another reference surface, and/or to ensure that the laser beam (40) is projected at a known angle to avoid the creation of inaccuracy or uncertainty.

In use, the first member (12) can be secured to a first of two objects to be engaged, such as a pipe or a tank, through use of the mounting bracket (26) or other securing device, as described previously. Alignment of the first member (12) with the Earth's surface, and/or the angular relationship of the first member (12) to a desired reference surface, can be measured using the level (30) or other angular measurement device. The laser device (36) can then be actuated to produce a laser beam (40) for providing a visible indication to the object with which the first object is to be engaged. The level (38) or other angular measurement device disposed in association with the laser device (36) can be used to determine the angular relationship between the laser device (36) and the Earth's surface, or another desired surface. The second and third members (14, 16) can then be pivoted along their respective axes (22, 24) such that the laser beam (40) provides a visible indication to a desired portion of the target object. The protractors (32, 34) or other angular measurement devices are then useable to determine the angular relationship between the members (12, 14, 16), and correspondingly, the angular offset of the target object relative to the first object along the axes (22, 24).

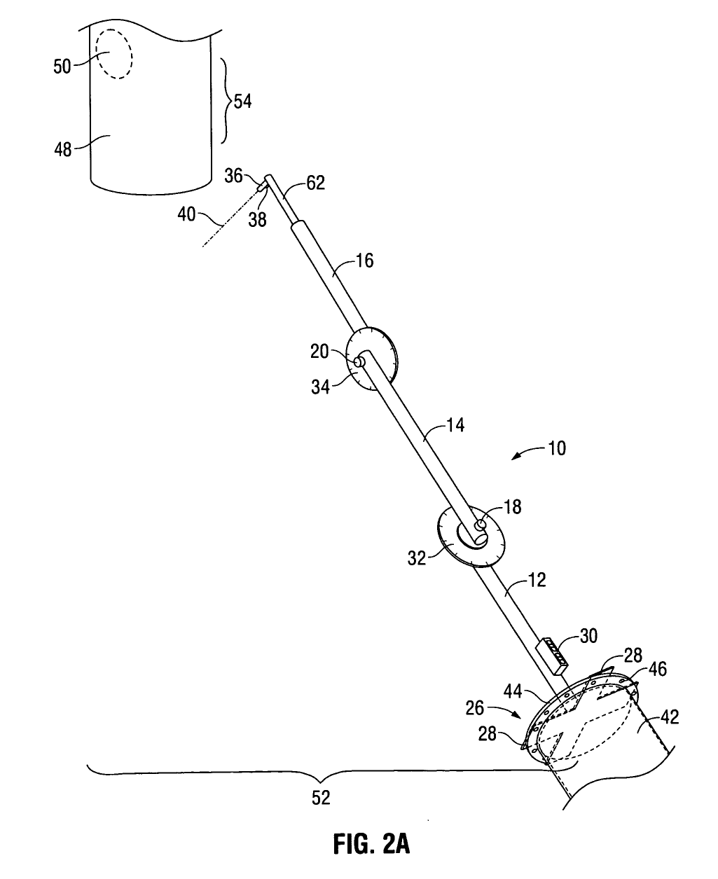

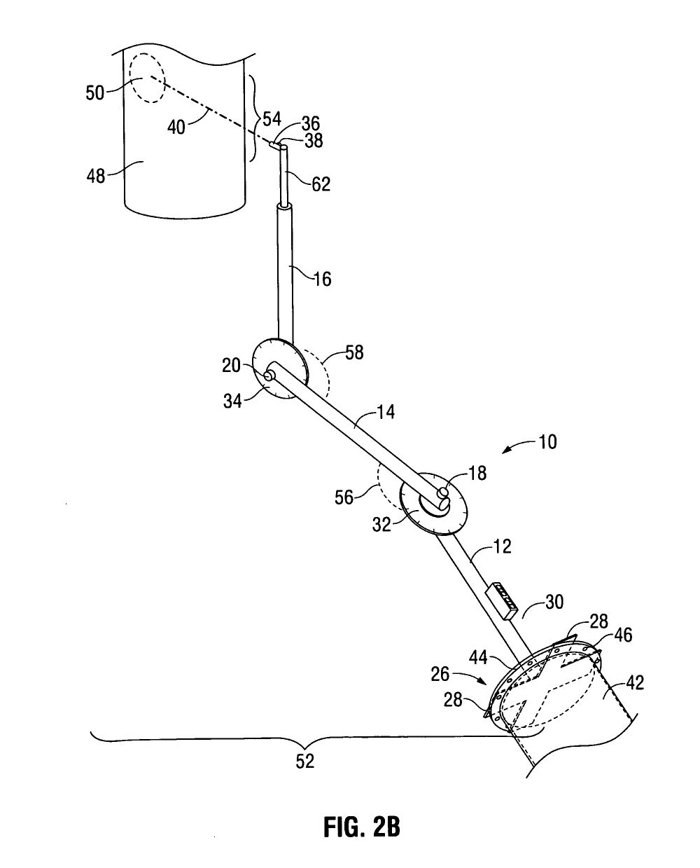

Referring now to FIG. 2A, an embodiment of an apparatus (10) usable within the scope of the present disclosure is shown, the apparatus (10) being of generally similar construction as the embodiment depicted in FIGS. 1A and 1B. As such, all like and/or corresponding parts have been provided with identical reference numerals. The apparatus (10) is shown having a first member (12) pivotally connected to a second member (14) at a first engagement (18), such that the second member (14) is moveable relative to the first member (12) along a generally horizontal axis. A third member (16) is shown pivotally connected to the second member (14) at a second engagement (20), such that the third member (16) is moveable relative to the second member (14) along a generally vertical axis. The engagements (16, 18) are shown as rotatable pins disposed through adjacent members, however as described previously, it should be noted that any manner of moveable engagement between each member (12, 14, 16) can be used without departing from the scope of the present invention. As described above, a first protractor (32) and a second protractor (34) are disposed in operative association with the first and second engagements (18, 20), respectively, such that the protractors (32, 34) are useable to determine the angles between adjacent members.

FIG. 2A also depicts a tubular member (42) having a flange (44) disposed on an end, the flange (44) having multiple orifices extending therethrough, of which an orifice (46) is labeled. Remote from the tubular member (42), a vessel (48) is shown. As described previously, under certain circumstances, the horizontal and/or vertical weld pattern, and/or other features of the vessel (48) can prevent formation of an orifice within the exterior of the vessel (48) to engage a conduit string. For illustrative purposes, FIG. 2A depicts a region (50) of the vessel (48) at which engagement with a conduit string will not interfere with any features of the vessel (48). The region (50) of the vessel (48) is offset from the tubular member (42) by both a horizontal distance (52) and a vertical distance (54), such that engagement between the tubular member (42) and vessel (48) will require one or more segments of conduit to be cut to selected angles and welded therebetween.

The first member (12) of the apparatus (10) is shown secured to the tubular member (42) through engagement of a mounting bracket (26) having bolts (28) or other fasteners thereon, through the orifices (46) of the flange (44). After engagement between the first member (12) and the tubular member (42), a level (30) disposed on the first member (12) is useable to align the first member (12) with the Earth's surface. A laser device (36) secured to the third member (16) is shown projecting a laser beam (40) therefrom, which is useable to provide a visible indication to the region (50) of the vessel (48).

Referring now to FIG. 2B, the apparatus (10) of FIG. 2A is shown after pivotal movement of the members (12, 14, 16) relative to one another has been undertaken, to cause the laser beam (40) to indicate the desired region (50) of the vessel (48), such that the angular offset between the region (50) and the tubular member (42) can be measured. Specifically, FIG. 2B depicts the second member (14) having been pivotally moved along a generally horizontal axis relative to the first member (12), such that a first angle (56) is defined therebetween. The size of first angle (56) corresponds, at least partially, to the horizontal distance (52, shown in FIG. 2A) between the region (50) and the tubular member (42), and the direct distance between the region (50) and the tubular member (42). The third member (16) is shown having been pivotally moved along a generally vertical axis relative to the second member (14), such that a second angle (58) is defined therebetween. The size of the second angle (58) corresponds, at least partially, to the vertical distance (54, shown in FIG. 2A) between the region (50) and the tubular member (42), and the direct distance between the region (50) and the tubular member (42).

In use, the members (12, 14, 16) can be pivoted relative to one another until the laser beam (40) projected using the laser device (36) provides a visible indication to the region (50) of the vessel (48). While any manner of moveable or fixed engagement between the laser device (36) and the third member (16) or other portion of the apparatus (10) is useable, FIG. 2B depicts the laser device (36), secured to the third member (16) using an adjustable arm (62), and having a level (38) disposed thereon to align the laser device (36) with the Earth's surface. The adjustable arm (62) can be telescoping, rotatable, and/or pivotable to enable the laser device (36) to be oriented to project the laser beam (40) in the direction of the vessel (48) independent of the angular relationship between the members (12, 14, 16). The protractors (32, 34) are then useable to measure the angular relationship between each of the members (12, 14, 16). The visual indication can be used to indicate the center of the region (50) within the vessel (48) to facilitate formation of an orifice in an accurate location, while the angular offset measured using the apparatus (10), optionally in combination with the direct distance between the region (50) and the tubular member (42), can be used to determine the optimal route, and the corresponding number and angles of conduit segments, useable to engage the tubular member (42) to the vessel (48). In an embodiment of the invention, the laser device (36) can include an integral distance measurement device, or alternatively, the apparatus (10) can have a separate distance measurement device disposed thereon, for determining the direct distance between the tubular member (42) and the region (50) of the vessel (48).

While FIGS. 2A and 2B depict a vessel (48) on which a region (50) for forming an orifice is known, and it is desirable to determine the angular offset between the tubular member (42) an the region (50), it should be understood that the depicted apparatus (10) can also be used when the necessary angular offset between objects is known, and it is desirable to determine the precise location of the region (50). For example, the second member (14) can be positioned at a known angle relative to the first member (12) using the first protractor (32), while the third member (16) can be positioned relative to the second member (14) at a known angle using the second protractor (34). Actuation of the laser device (36) can then cause a visible indication to be provided to a location corresponding to the angles between the members (12, 14, 16), which have been provided therebetween using the protractors (32, 34). The visible indication can correspond to the direct center of an appropriate region through which an orifice can be formed, such that an operator can cut such an orifice at a selected diameter about the visible indication.

Embodiments of the present invention are thereby useable to efficiently and accurately determine the angular offset between any two objects, to thereby enable the most direct and/or optimal method by which the objects can be engaged. Embodiments of the present invention are also useable to facilitate this engagement by indicating locations, objects, and/or portions of objects disposed angularly offset relative to a first object.

While various embodiments of the present invention have been described with emphasis, it should be understood that within the scope of the appended claims, the present invention might be practiced other than as specifically described herein.

What is claimed is:

1. An apparatus for determining angular offset and facilitating engagement between conduits and vessels, the apparatus comprising:
a first member comprising at least one fastener disposed thereon and adapted for engagement with a first object;
a first measurement device in operable association with the first member for determining an angular relationship between the first member and a surface;
a second member engaged with the first member and pivotally moveable relative to the first member along a first axis;
a second measurement device in operable association with the first member and the second member, wherein the second measurement device determines an angular relationship between the first member and the second member;
a third member engaged with the second member and pivotally moveable relative to the second member along a second axis;
a third measurement device in operable association with the second member and the third member, wherein the third measurement device determines an angular relationship between the second member and the third member; and
a location indication device engaged with the third member for indicating a location on a second object to be engaged with the first object.

2. The apparatus of claim 1, wherein said at least one fastener comprises a mounting bracket having at least one protruding member for engagement with an orifice within a flange of a tubular member.

3. The apparatus of claim 2, wherein the mounting bracket further comprises at least one adjustable member for accommodating tubular members having multiple diameters.

4. The apparatus of claim 1, wherein said at least one fastener comprises at least one ferromagnetic member for engagement with an at least partially ferrous surface of the first object.

5. The apparatus of claim 1, wherein the first measurement device comprises a bubble level, a water level, a spirit level, a laser line level, an inclinometer, a plumb, or combinations thereof.

6. The apparatus of claim 1, wherein the first axis is generally perpendicular to the second axis.

7. The apparatus of claim 1, wherein at least one of the first axis or the second axis is generally parallel to the Earth's surface.

8. The apparatus of claim 1, wherein the second measurement device, the third measurement device, or combinations thereof, comprise a protractor, a clinometer, a goniometer, an angular sensor, or combinations thereof.

9. The apparatus of claim 1, wherein the location indication device comprises a light emitting device, a laser, or combinations thereof.

10. The apparatus of claim 1, further comprising a distance measurement device in operative association with the location indication device, wherein the distance measurement device determines a distance between the first object and the second object.

11. The apparatus of claim 1, further comprising a fourth measurement device in operable association with the location indication device for determining an angular relationship between the location indication device and the surface.

12. The apparatus of claim 11, wherein the fourth measurement device comprises a bubble level, a water level, a spirit level, a laser line level, an inclinometer, a plumb, or combinations thereof.

13. An method for determining angular offset and facilitating engagement between conduits and vessels, the method comprising the steps of:
engaging a first member with a first object;
aligning the first member with a surface;
positioning a second member relative to the first member, wherein an angular relationship between the first member and the second member corresponds to an angular offset of a second object relative to the first object along a first axis;
positioning a third member relative to the second member, wherein an angular relationship between the second member and the third member corresponds to an angular offset of the second object relative to the first object along a second axis; and
measuring the angular relationship between the first member and the second member, and the angular relationship between the second member and the third member, thereby determining the angular offset of the second object relative to the first object along the first axis and the second axis.

14. The method of claim 13, wherein the step of engaging the first member with the first object comprises engaging at least one fastener of the first member with a corresponding orifice of the first object, engaging at least one ferromagnetic element of the first member with an at least partially ferrous surface of the first object, or combinations thereof.

15. The method of claim 13, wherein the step of aligning the first member with the surface comprises positioning the first member in a generally parallel orientation with respect to the Earth's surface.

16. The method of claim 13, further comprising the step of using a location indication device in operative association with the second member, the third member, or combinations thereof to produce an indication, wherein the step of positioning the second member relative to the first member comprises moving the second member along the first axis until the indication is aligned with the second object with respect to the first axis, and the step of positioning the third member relative to the second member comprises moving the third member along the second axis until the indication is aligned with the second object with respect to the second axis.

17. The method of claim 16, wherein the step of using the location indication device to produce the visible indication comprises actuating a light source, a laser, or combinations thereof, to provide light to a selected portion of the second object.

18. The method of claim 16, further comprising the step of aligning the location indication device with the surface.

19. The method of claim 13, wherein the step of measuring the angular relationship between the first member and the second member, and the angular relationship between the second member and the third member, comprises using at least one measurement device disposed in operable association with the first member, the second member, the third member, or combinations thereof.

20. The method of claim 13, further comprising the step of measuring a distance between the first object and the second object to facilitate engagement of the first object with the second object using the distance and the angular offset of the second object relative to the first object.

21. An apparatus for determining angular offset between objects for facilitating engagement between said objects, the apparatus comprising:
a plurality of members, wherein each member is engaged to and movable relative to at least one other of said members;
at least one angular measurement device disposed in operable association with an engagement between said members, wherein said at least one angular measurement device determines an angle between two of said members; and
a location indication device disposed in operable association with at least one of said members for indicating a location on an object.

22. An method for determining angular offset between objects for facilitating engagement between said objects, the method comprising the steps of:
engaging an apparatus comprising a plurality of members and a location indication device to a first object;
actuating the location indication device to produce an indication;
moving at least one of said members relative to at least one other of said members to position the indication at a selected location relative to a second object; and
measuring an angular relationship between each at least one of said members and each at least one other of said members to determine the angular offset between the first object and the second object.
